(19) United States
(12) Patent Application Publication
(10) Pub. No.: US 2016/0306822 A1
(43) Pub. Date: Oct. 20, 2016

(54) LOAD BALANCING OF QUERIES IN REPLICATION ENABLED SSD STORAGE

(71) Applicant: Samsung Electronics Co., Ltd., Suwon-si (KR)

(72) Inventor: Suraj Prabhakar WAGHULDE, Fremont, CA (US)

(21) Appl. No.: 14/827,311

(22) Filed: Aug. 15, 2015

Related U.S. Application Data
(60) Provisional application No. 62/149,510, filed on Apr. 17, 2015.

(51) Int. Cl. G06F 17/30; H04L 12/803; G06F 11/14; G06F 12/02

(52) U.S. Cl. CPC G06F 17/30212; G06F 12/0253; H04L 47/125; G06F 11/1402; G06F 17/30584

(57) ABSTRACT

A replication manager for a distributed storage system comprises an input/output (I/O) interface, a device characteristics sorter, a routing table reorderer and a read-query load balancer. The I/O interface receives device-characteristics information for each persistent storage device of a plurality of persistent storage devices in which one or more replicas of data are stored on the plurality of persistent storage devices. The device characteristics sorter sorts the device-characteristics information based on a free block count for each persistent storage device. The routing table reorderer reorders an ordering of the replicas on the plurality of persistent storage devices based on the free block count for each persistent storage device, and the read-query load balancer selects a replica for a received read query by routing the received read query to a location of the selected replica based the ordering of the replicas stored on the plurality of persistent storage devices.

### CROSS-REFERENCE TO RELATED APPLICATIONS

This application claims the benefit of U.S. Provisional Patent Application No. 62/149,510 filed Apr. 17, 2015, the contents of which are hereby incorporated by reference herein, in their entirety, for all purposes.

### BACKGROUND

Data replication is used in data storage systems for reliability, fault-tolerance, high data availability and high-query performance purposes. Almost all distributed storage systems, such as NoSQL/SQL databases, Distributed File Systems, etc., have data replication. Many data storage systems utilize persistent storage devices, such as Solid-State Drives (SSDs) and Non-Volatile Memory Express (NVMe) devices.

A garbage collection process is an operation within a persistent storage device that is important for the I/O performance of the device. In particular, a garbage collection operation is a process of relocating existing data in a persistent storage device to new locations, thereby allowing surrounding invalid data to be erased. Memory within persistent storage devices, such as an SSD, is divided into blocks, which is further divided in pages. Although data can be written directly into an empty page of an SSD, only whole blocks within an SSD can be erased. In order to reclaim space taken by invalid data, all the valid data from one block must be copied and written into the empty pages of another block. Afterward, the invalid data in the block is erased, making the block ready for new valid data.

Typically, a persistent storage device, such as an SSD, undergoes a self-initiated garbage collection process if there is less than a threshold amount of total free blocks available for use. When an SSD is almost full with partial garbage data, a garbage collection process running every few seconds causes significant adverse latency spikes for read/write workloads. Moreover, because it is difficult predict I/O workload in any storage system, it is difficult to schedule a garbage collection operation so that I/O performance is not adversely affected.

### SUMMARY

Embodiments disclosed herein relate systems and techniques that improve read query performance in a distributed storage system by utilizing characteristics of persistent storage devices, such as free block count and device type characteristics, for prioritizing access to replicas in order to lower read query latency.

Embodiments disclosed herein provide a method, comprising: determining a free block count for each persistent storage device of a plurality of persistent storage devices in a distributed storage system, the plurality of persistent storage devices storing a plurality of replicas of data; determining an ordering of the replicas of data stored on the plurality of persistent storage devices based on the determined free block count; and load balancing read queries by routing a read query to a replica location based on the determined ordering of replicas.

Embodiments disclosed herein provide a replication manager for a storage system, comprising an input/output (I/O) interface, a device characteristics sorter, a routing table sorter, and a read-query load balancer. The I/O interface receives free block count information for each persistent storage device of a plurality of persistent storage devices in the storage system in which one or more replicas of data stored in the storage system are stored on the plurality of persistent storage devices. The device characteristics sorter sorts the received free block count information for each persistent storage device. The routing table sorter sorts a routing table of the replicas of data stored on the plurality of persistent storage devices based on the free block count for each persistent storage device and to identify in the table replicas of data stored on persistent storage device having a free block count less than or equal to a predetermined amount of free blocks. The read-query load balancer selects a replica for a received read query by routing the received read query to a location of the selected replica based the table of the replicas of data stored on the plurality of persistent storage devices.

Embodiments disclosed herein provide a non-transitory machine-readable medium comprising a plurality of instructions that in response to being executed on a computing device cause the computing device to prioritize access to replicas stored on a plurality of persistent storage devices in a distributed storage system by: determining device characteristics for each persistent storage device of a plurality of persistent storage devices in a distributed storage system, the plurality of persistent storage devices storing a plurality of replicas of data, and the device characteristics comprising a free block count; determining an ordering of the replicas of data stored on the plurality of persistent storage devices based on the determined device characteristics; and load balancing read queries by routing a read query to a replica location based on the determined ordering of replicas.

### BRIEF DESCRIPTION OF THE DRAWINGS

Example embodiments will be more clearly understood from the following detailed description taken in conjunction with the accompanying drawings. The Figures represent non-limiting, example embodiments as described herein.

FIG. 1A depicts an exemplary partition arrangement in a distributed storage system that utilizes replication;

FIG. 1B depicts an exemplary arrangement of a request routing table for distributed storage system of FIG. 1A;

FIG. 2A depicts an exemplary embodiment of a distributed storage system that comprises a replication manager that utilizes persistent storage device characteristics to avoid routing a read request to a replica on a persistent storage device that may soon undergo a garbage collection operation according to the subject matter disclosed herein;

FIG. 2B depicts a functional block diagram of an exemplary embodiment of a replication manager according to the subject matter disclosed herein;

FIG. 3 depicts a flow diagram of an exemplary embodiment of a replica ordering process according to the subject matter disclosed herein;

FIG. 4 depicts a flow diagram of an exemplary embodiment of an external garbage triggering process according to the subject matter disclosed herein;

FIG. 5 depicts a flow diagram of an exemplary embodiment of a read-query load balancing process according to the subject matter disclosed herein;

FIG. 6A depicts a configuration of a distributed storage system that uses synchronous replication by partitioning data;

FIG. 6B depicts a configuration of a distributed storage system that uses synchronous pipelined replication in which data is written to selected replicas in a pipelined fashion;

FIG. 6C depicts a configuration of a distributed storage system that uses an asynchronous replication by consistent hashing in which a cluster of storage devices (nodes) acts as a peer-to-peer distributed storage system;

FIG. 6D depicts a configuration of a distributed storage system that uses asynchronous replication by replicating the partitioned range of configurable size and in which a cluster in the distributed storage system has a master node;

FIG. 6E depicts a configuration of a distributed storage system that uses synchronous/asynchronous multi-master or master-slave replication with manual data partitioning;

FIG. 6F depicts a configuration of a distributed storage system that uses a master-slave replication topography; and

FIG. 7 depicts an exemplary embodiment of an article of manufacture comprising a non-transitory computer-readable storage medium having stored thereon computer-readable instructions that, when executed by a computer-type device, results in any of the various techniques and methods to improve read query performance in a distributed storage system by utilizing characteristics of persistent storage devices, such as free block count and device type characteristics, according to the subject matter disclosed herein.

### DESCRIPTION OF EMBODIMENTS

Embodiments disclosed herein relate to replication of data in distributed storage systems. More particularly, embodiments disclosed herein relate systems and techniques that improve read query performance in a distributed storage system by utilizing characteristics of persistent storage devices, such as free block count and device type characteristics, for prioritizing access to replicas in order to lower read query latency.

Various exemplary embodiments will be described more fully hereinafter with reference to the accompanying drawings, in which some exemplary embodiments are shown. As used herein, the word “exemplary” means “serving as an example, instance, or illustration.” Any embodiment described herein as “exemplary” is not to be construed as necessarily preferred or advantageous over other embodiments. The subject matter disclosed herein may, however, be embodied in many different forms and should not be construed as limited to the exemplary embodiments set forth herein. Rather, the exemplary embodiments are provided so that this description will be thorough and complete, and will fully convey the scope of the claimed subject matter to those skilled in the art. In the drawings, the sizes and relative sizes of layers and regions may be exaggerated for clarity.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “module” refers to any combination of software, firmware and/or hardware configured to provide the functionality described herein. The software may be embodied as a software package, code and/or instruction set or instructions, and “hardware,” as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Unless otherwise defined, all terms (including technical and scientific terms) used herein have the same meaning as commonly understood by one of ordinary skill in the art to which subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Data storage systems use replication to store the same data on multiple storage devices based on configurable “replication factors” that specify how many replicas are contained within the storage system. Replication in distributed storage systems uses data partitioning and is handled by several components that are collectively referred to as a “replication manager.” The replication manager is responsible for partitioning data and replicating the data partition across multiple nodes in a cluster based on a replication factor (i.e., the number of copies the cluster maintains). Data is divided into partitions (or shards) mainly using a data chunk size, a key range, a key hash, and/or a key range hash (i.e., a virtual bucket). The replication manager stores a mapping table containing mappings to devices for each data partition, and distinguishes between primary and backup data replicas. The mapping table can be generally referred to as a request routing table.

Embodiments disclosed herein include a replication manager that utilizes persistent storage device characteristics, such as free block count and device type, to enhance replication policy by avoiding routing a read request to a replica on a persistent storage device that will soon undergo a garbage collection operation. The device characteristics are maintained in a device characteristics table that is updated in a configurable time interval that can be based on the write workload of the system, which enables the replication manager to load balance the I/O workload effectively. When the replication manager determines that a persistent storage device has less than a threshold amount of free blocks available, the persistent storage device is reordered to be last in a request routing table, and the persistent storage device is externally triggered to perform a garbage collection operation. Read queries are load balanced by routing subsequently received read queries to different replica locations using an updated replica order defined in the request routing table that avoids interference between a read request and the externally triggered garbage collection operation.

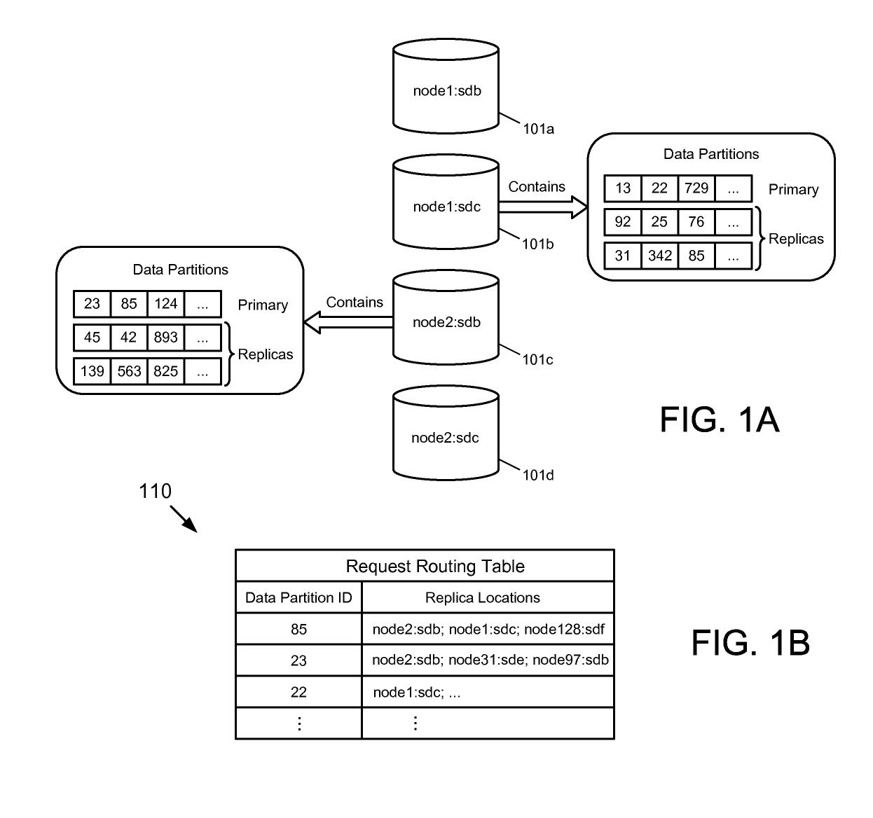

FIG. 1A depicts an exemplary partition arrangement in a distributed storage system 100 that utilizes replication. Distributed storage system 100 comprises a plurality of persistent storage devices 101a-101d. In one exemplary embodiment, persistent storage devices 101a-101d each comprise an SSD or an NVMe device. Although distributed storage system 100 is depicted in FIG. 1A as only comprising persistent storage devices 101a-101d, in should be understood that distributed storage system 100 also comprises, not-shown, well-known infrastructure for interconnecting and controlling the storage devices. It should also be understood that distributed storage system 100 could comprise any number of persistent storage devices, and that distributed storage system 100 could also comprise non-persistent storage devices that are not shown in FIG. 1A.

As depicted in FIG. 1A, storage device 101a is identified as node1:volume sdb. Storage device 101b is identified as node1:volume sdc. Storage device 101c is identified as node2: volume sdb, and storage device 101d is identified as node2: volume sdc. To serve a request for data partition ID 85, the read request would be routed to node2:volume sdb in a well-known manner because node2 contains a data partition ID 85 that is a primary data replica of data partition ID 85. Node1:volume sdc contains a backup replica of data partition ID 85.

FIG. 1B depicts an exemplary arrangement of a request routing table (mapping table) 110 for distributed storage system 100 of FIG. 1A. Request routing table 110 indicates that for data partition ID 85, node2:volume sdb is a primary address for data partition ID 85, and node1:volume sdc and node128:volume sdf (not shown in FIG. 1A) are addresses for replicas of data partition ID 85. If a request is received for data partition ID 85, the request routing table 110 indicates that the request will be routed to node2:volume sdb, which is the primary address location for data partition ID 85.

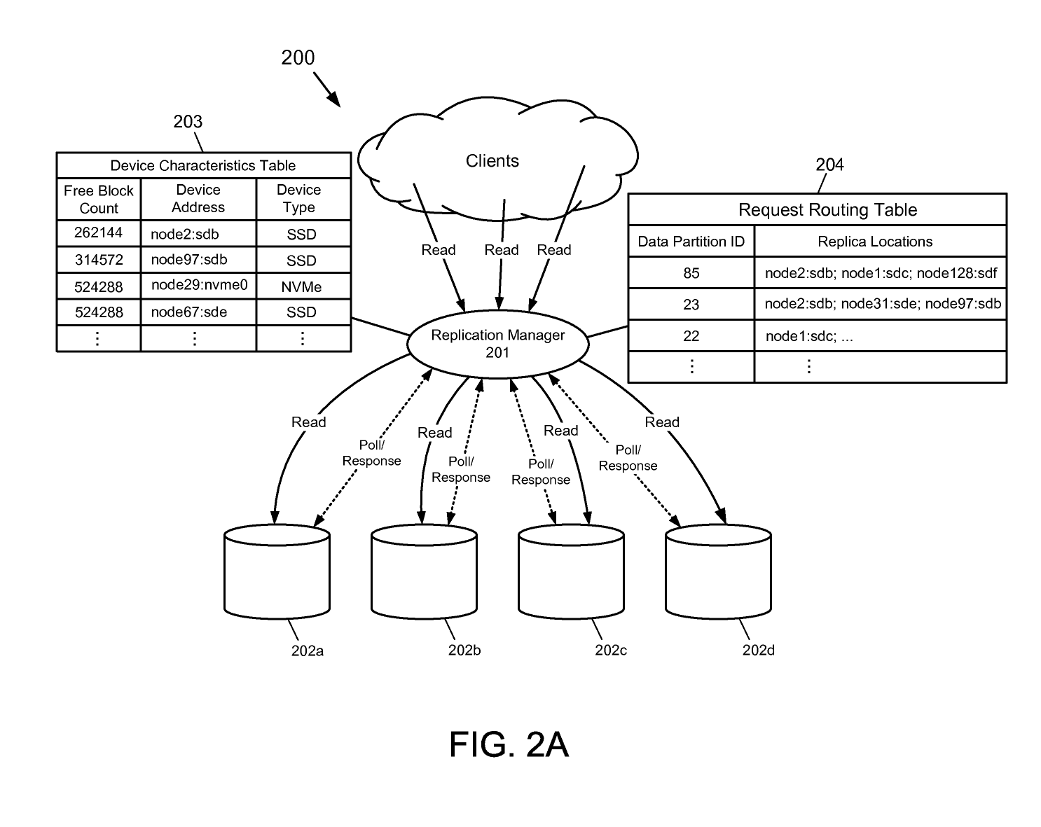

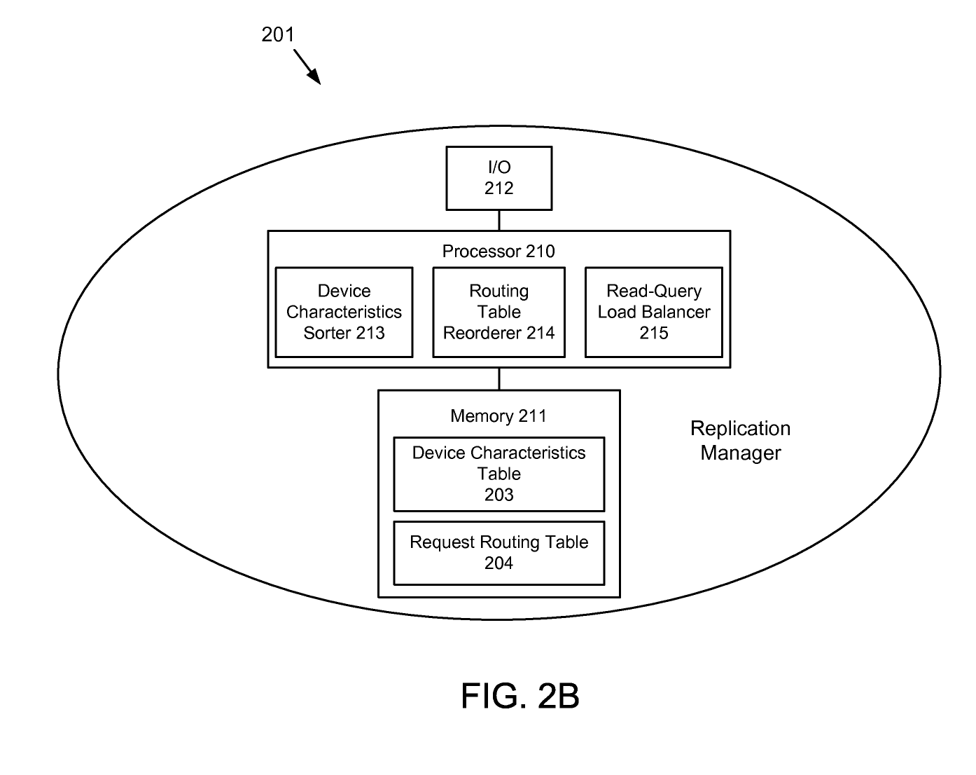

FIG. 2A depicts an exemplary embodiment of a distributed storage system 200 that comprises a replication manager that utilizes persistent storage device characteristics to avoid routing a read request to a replica on a persistent storage device that may soon undergo a garbage collection operation according to the subject matter disclosed herein. Distributed storage system 200 comprises a replication manager 201 and a plurality of persistent storage devices 202a-202d. In one exemplary embodiment, persistent storage devices 202a-202d each comprise an SSD or an NVMe device.

Although distributed storage system 200 is depicted in FIG. 2A as only comprising persistent storage devices 202a-202d, in should be understood that distributed storage system 200 also comprises, not-shown, well-known infrastructure for interconnecting and controlling the storage devices. It should also be understood that distributed storage system 200 could comprise any number of persistent storage devices, and that distributed storage system 200 could also comprise non-persistent storage devices that are not shown in FIG. 2A.

In one exemplary embodiment, replication manager 201 periodically polls storage devices 202a-202d, and each storage device responds with device-characteristics information such as, but not limited to, an identity of the storage device, the free block count of the storage device, and the storage-device type. In another exemplary embodiment, storage devices 202a-202d are configured to periodically send device-characteristics information to replication manager 201 such as, but not limited to, an identity of the storage device, the free block count of the storage device, and the storage-device type. In one exemplary embodiment, the device-characteristics information is sent by the storage devices, for example, every 15 seconds. In another exemplary embodiment, the device-characteristics information is send by the storage devices using an interval that is different from 15 seconds and/or is based on device write workload. In one exemplary embodiment, after device-characteristics information is initially sent, subsequent updates of device-characteristics information sent from a storage device could include, but might not be limited to, at least an identification of a storage device and the free block count of the device.

FIG. 2B depicts a functional block diagram of an exemplary embodiment of a replication manager 201 according to the subject matter disclosed herein. Replication manager 201 comprises a processor 210 coupled to a memory 211 and an I/O interface 212. Processor 210 comprises at least a device characteristics sorter 213, a routing table reorderer 214, and a read-query load balancer 215. Memory 211 is capable of storing a device characteristics table 203 and a request routing table 204. Each of processor 210, memory 211, I/O interface 212, device characteristics sorter 213, routing table reorderer 214 and read-query load balancer 215 may comprise one or more modules that may be any combination of software, firmware and/or hardware configured to provide the functionality described herein. The software may be embodied as a software package, code and/or instruction set or instructions, and “hardware,” as used in any implementation described herein, may include, for example, singly or in any combination, hardwired circuitry, programmable circuitry, state machine circuitry, and/or firmware that stores instructions executed by programmable circuitry.

I/O interface 212 receives requests from clients and device-characteristics information from persistent storage devices. Processor 210 uses the received device-characteristics information to update a device characteristics table 203. FIG. 2A depicts an exemplary arrangement of a device characteristics table 203. In one exemplary embodiment, the device characteristics table 203 contains, but is not limited to, a free block count, address information for each persistent device in the storage system along with the corresponding node address, and device type. In one exemplary embodiment, a device characteristics sorter 213 sorts the device characteristics table 203 based on free block count so that the devices having the lowest free block count are moved to the top of the device characteristics table. A persistent storage device contained in the device characteristics table 203 that has less than a predetermined amount of free blocks is identified by replication manager 201 and routing table reorderer 214 reorders a request routing table 204 so that the identified persistent storage device is last in the request routing table 204. FIG. 2A depicts an exemplary arrangement of a request routing table 204. A persistent storage device that has been identified to contain fewer than the predetermined amount of free blocks is externally triggered by the system to perform a garbage collection operation to increase the free block count of the device. The reordering of the device to be last in the request routing table 204 avoids read requests received from clients from being routed to replication locations in which a garbage collection operation will soon occur to avoid a read request and a garbage collection operation from interfering with each other and to improve the retrieval performance of the system. Additionally, read queries are load balanced by a read-query load balancer 215 of replication manager 201 by routing read queries to different replica locations using the replica order defined in the request routing table 204. Write requests can make use of the device characteristics table 203 by routing a new data writing request to a device having the highest free block count.

In one exemplary embodiment, the threshold for determining whether the free block count of a persistent storage device is too small is if the free block count is less than or equal to 5% of the total block count of the storage device. In another exemplary embodiment, the threshold for determining whether the free block count of a storage device is too small is different from a free block count being less than or equal to 5% of the total block count of the storage device. In another exemplary embodiment, the threshold for determining whether the free block count of a storage device is too small can be based on the write workload that the storage device experiences.

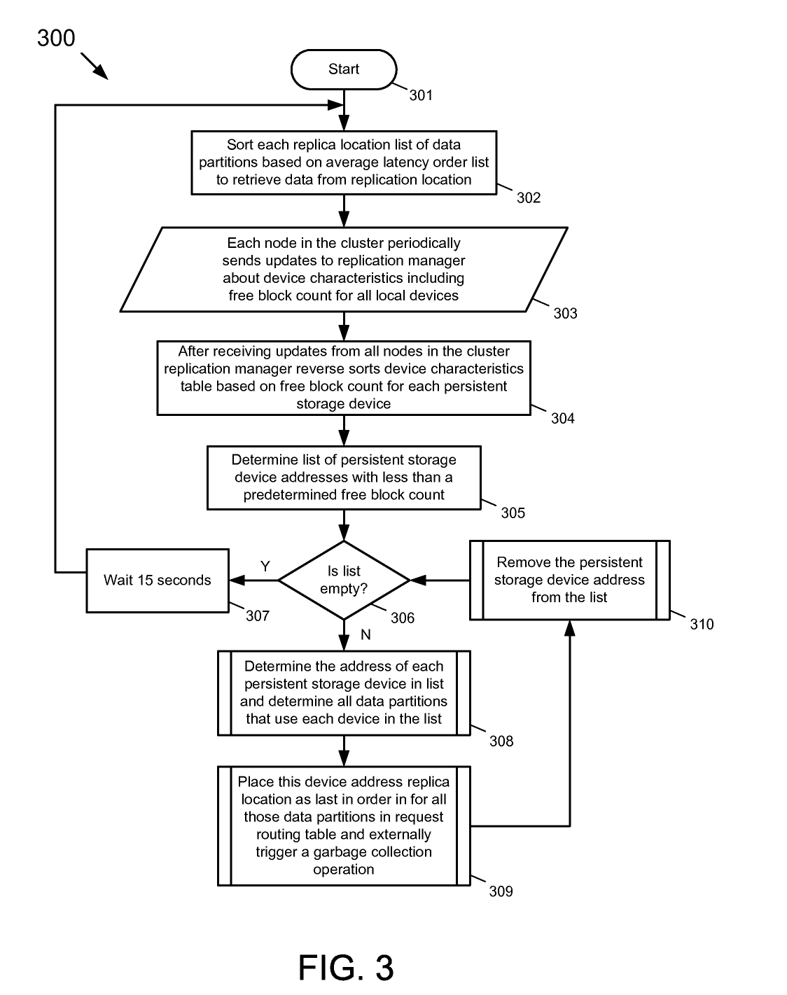

FIG. 3 depicts a flow diagram of an exemplary embodiment of a replica ordering process 300 according to the subject matter disclosed herein. The process starts at operation 301. At operation 302, each entry in a replica location list of data partitions is sorted based on an average latency to retrieve a predetermined amount of data from each partition location. In one exemplary embodiment, the predetermined amount of data retrieved to determine an average latency is 4 kBytes. In another exemplary embodiment, the predetermined amount of data retrieved is different from 4 kBytes. At operation 303, each node in the cluster periodically sends device-characteristic information updates to the replication manager that includes, but is not limited to, an identity of the storage device, the free block count of the storage device, and the storage-device type. In one exemplary embodiment, the device-characteristic information updates are sent in response to a periodic polling from the replication manager. In another exemplary embodiment, the updates are periodically sent to the replication manager without polling. In one exemplary embodiment, updates are sent, for example, every 15 seconds, although a different period of time could alternatively be used.

At operation 304, after receiving updated from all nodes, the replication manager reverse sorts a device characteristics table, such as device characteristics table 203 in FIG. 2, based on free block count for each persistent storage device so that persistent storage devices having the highest free block count are positioned near the top of the device characteristics table. In another exemplary embodiment, the persistent storage devices having the lowest free block count are sorted to be positioned near the bottom of the device characteristics table. In yet another exemplary embodiment, the persistent storage devices having the highest free block count are sorted and identified in the device characteristics table without repositioning the device within the table. In still another exemplary embodiment, a routing table listing the various persistent storage device of the system could be sorted and a persistent storage device is removed from (identified or flagged in) the routing table if the persistent storage device has a free block count less than or equal to a predetermined amount of free blocks, such that the system is aware that such storage device will soon undergo (or has been ordered to undergo) garbage collection.

At operation 305, a list is obtained of all persistent storage device addresses having less than a predetermined free block count. In one exemplary embodiment, the list obtained at operation 305 contains all persistent storage devices having less than 1,000,000 free blocks. In another exemplary embodiment, the list obtained at operation 305 contains all persistent storage devices having less than an amount of free blocks that is different from 1,000,000 free blocks. In still another exemplary embodiment, the list obtained at operation 305 contains all persistent storage devices having a free block count that are less than a given percentage (e.g. 5%) of the total block count for the device. For example, if a device has 1,000,000 blocks, then if the free block count for the device goes below 50,000 blocks, then the device will be contained in the list. At operation 306, it is determined whether the list is empty. If so, flow continues to operation 307 where a predetermined period of time is allowed to elapse before returning to operation 302. In one exemplary embodiment, the predetermined period of time allowed to elapse in operation 307 is 15 seconds. In another exemplary embodiment, the predetermined period of time allowed to elapse in operation 307 is different from 15 seconds.

If, at operation 306, it is determined that the list of all persistent storage device addresses having a free block count that is less than the predetermined amount is not empty, flow continues to operation 308 where the address of each persistent storage device in the list and all data partitions that use the persistent storage devices in the list are determined. Flow continues to operation 309 where the device replica addresses for all partitions determined in operation 308 are placed last in order in the request routing table, and a garbage collection operation is externally triggered for each persistent storage device in the list. After the device has been placed last in order in the request routing list, the replication manager informs a node hosting the persistent storage device to invoke a garbage collection operation on the persistent storage device because the replication manager will not route any read queries to the device for predetermined period of time (e.g., approximately 50 seconds). In one exemplary embodiment, the replication manager communicates through I/O interface 212 in a well-known manner to such a node to externally trigger the persistent storage device to perform a garbage collection operation.

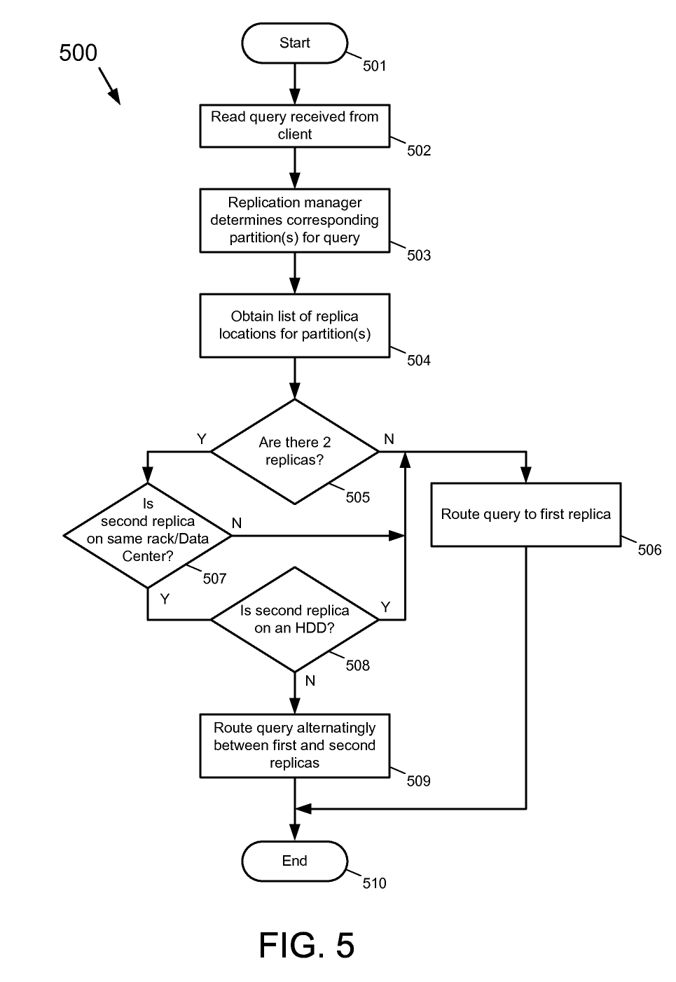

The node can then issue a garbage collection command to the particular device that will not interfere with read queries during the predetermined period of time. Alternatively, the replication manager issues a garbage collection command directly to the particular device. During the period of time that a garbage collection operation completes, other replicas in the request routing table serve new read requests in which a load-balancing technique that is disclosed in connection with FIG. 5 is used.

Flow continues to operation 310 where the address of each persistent storage device in the list determined in operation 305 is removed from the list obtained in operation 305 because an externally triggered garbage collection operation has increased the free block count to exceed the predetermined free block count threshold of operation 305. Flow returns to operation 306.

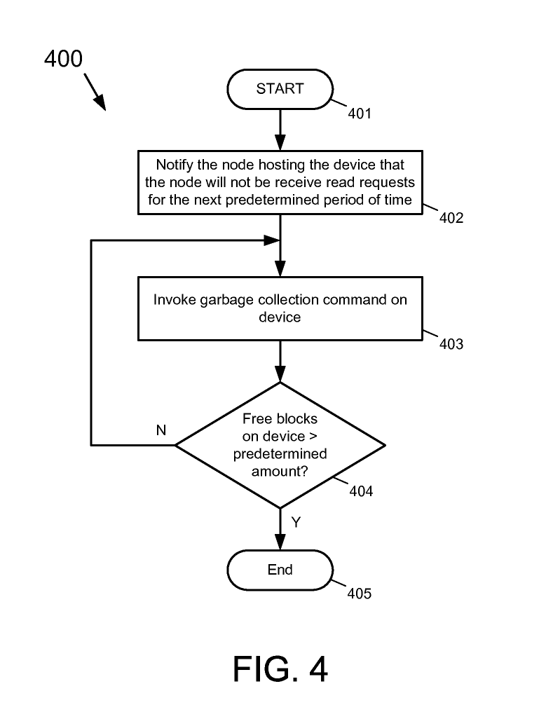

FIG. 4 depicts a flow diagram of an exemplary embodiment of an external garbage triggering process 400 according to the subject matter disclosed herein. In one exemplary embodiment, external garbage triggering process 400 corresponds to operation 309 of replica ordering process 300 of FIG. 3. Process 400 starts at operation 401. At operation 402, the node hosting a device that has been placed last in order in the request routing table is informed that the node will not receive read requests for the particular device for a predetermined period of time. In one exemplary embodiment, the predetermined period of time is, for example, 50 seconds. In another exemplary embodiment, the predetermined period of time is different from 50 seconds.

At operation 403, a garbage collection operation is invoked on the particular device. At operation 404, it is determined whether the number of free blocks on the device is greater than a predetermined amount. The number of free blocks that a garbage collection operation should produce should be large enough so that the time between external triggerings of garbage collection operations provides a sufficiently large period of time between the garbage collection operations so that system performance is not adversely affected.

If, at operation 404, it is determined that the number of free blocks on the device is less than the predetermined amount, flow returns to operation 403. A determination at operation 404 that the number of free blocks that were produced at operation 403 immediately preceding operation 404 is less than the predetermined amount may occur because the device may have experienced a large number of writes prior to operation 403. If at operation 404, it is determined that the number of free blocks on the device is greater than the predetermined amount, flow continues to operation 405 where the process ends.

As a persistent storage device completes a garbage collection operation and increases its free block count, the periodic updates of device characteristics information received by the replication manager will cause the device characteristics and the request routing tables to be updated, and the persistent storage device will again become available in the request routing table.

FIG. 5 depicts a flow diagram of an exemplary embodiment of a read-query load balancing process 500 according to the subject matter disclosed herein. Process 500 starts at operation 501. At operation 502, a read query is received from a client. At operation 503, the replication manager determines the data partitions corresponding to the query. At operation 504, the list of replica locations is obtained for the data partitions determined in operation 503. At operation 505, it is determined whether there are two (or more) replicas for the data partitions determined in operation 503. If not, flow continues to operation 506 where the read query is routed to the first replica based, in one exemplary embodiment, on the average latency order list determined in operation 302 of FIG. 3, and then to operation 510 where the process ends.

If, at operation 505, it is determined that there are two (or more) replicas for the data partitions, flow continues to operation 507 where it is determined whether the location of the second replica and the location of the first replica are, for example, on the same rack of a data center. If not, flow continues to operation 506. If, at operation 507, it is determined that the location of the second replica and the location of the first replica are on the same rack of a data center, flow continues to operation 508 where it is determined whether the second replica is located on a hard disk drive (HDD). If not, flow continues to operation 506. If, at operation 508, it is determined that the second replica is not located on an HDD, flow continues to operation 509 where the read query and subsequent read queries for the same data partition are alternatingly routed between the first and second replicas. In an embodiment in which there are more than two replicas, operation 509 would route subsequently received read queries alternatingly between all of the replicas. Flow continues to operation 510 where the process ends. It should be understood that there may be exemplary embodiments in which additional replicas are stored on two or more HDDs, in which case a read-query load balancing process according to the subject matter disclosed herein would generally operate similar to that disclosed herein and in FIG. 5. There may be a situation, however, in which a garbage collection operation may take less time than redirecting a read query to a replica on remotely located HDD, in which case it may, therefore, be best to wait for a garbage collection operation to occur rather than redirect a read query to the replica on the remotely located HDD.

It should be noted that the subject matter disclosed herein relates to handling read queries in a distributed storage system containing persistent storage devices. Write requests are handled by always routing write data to all of the replica devices for data consistency purposes. Thus, guarantees provided by the storage system relating to Consistency, Availability and Partition tolerance (CAP) and to Atomicity, Consistency, Isolation, Durability (ACID) are not violated because a read request can still be served from the last replica, if required, even if it is undergoing garbage collection. Moreover, the techniques disclosed herein do not make any changes in the fault tolerance logic of distributed storage systems.

It should also be noted that there is a very rare chance that a master and a replica might undergo garbage collection at the same time because data partitions are distributed based on replication patterns, such as asynchronous replication by consistent hashing. Consequently, a response to a read request will be adversely impacted; however, the subject matter disclosed herein avoids such a situation by making sure that read queries are served without any interference with garbage collection on the device by reordering the request routing table. To avoid a situation in which there are only two replicas and both are on devices undergoing a garbage collection operation, a condition could be placed before triggering a garbage collection at operation 403 that there must be at least one other replica location available for that data partition that is not undergoing a garbage collection operation.

Distributed storage systems generally use one of several different configurations, or environments, to provide data replication based on automatic partitioning (i.e., sharding) of data. Request routing policies are based on network topology (such as used by the Hadoop Distributed File System (HDFS)) or are static and are based on primary (master) replica and secondary (back-up) replicas. Accordingly, the techniques disclosed herein are applicable to distributed storage system having any of the several different configurations as follows. That is, a replication manager that is configured to use device characteristics, such as a free block count and a device type, that are received from persistent storage devices to update a device characteristics table based on the received updates as disclosed herein can be used with a distributed storage system having any one of the several different configurations described below. Such a replication manager would also reorder persistent storage devices in a request routing table based on the free block count of the respective persistent storage devices, as disclosed herein.

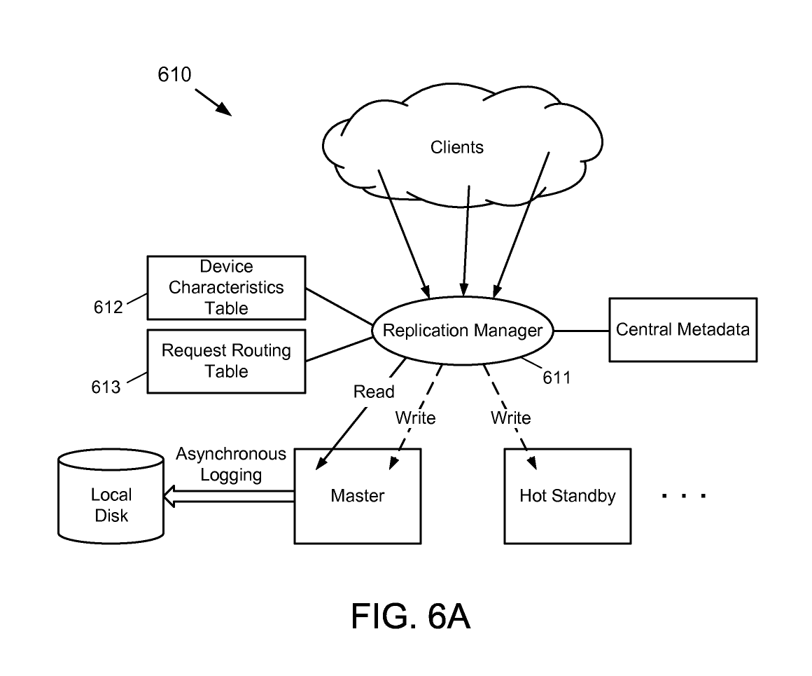

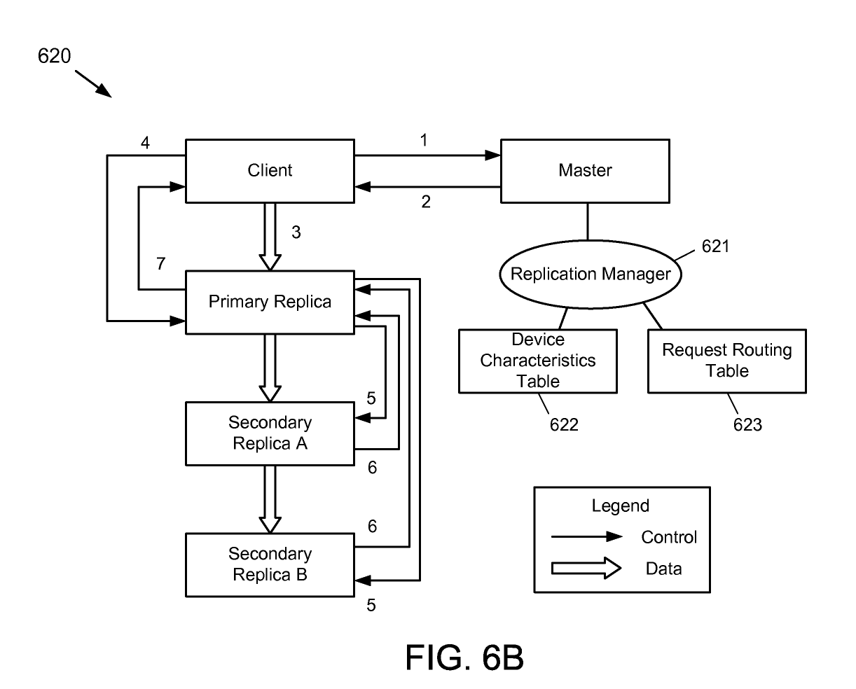

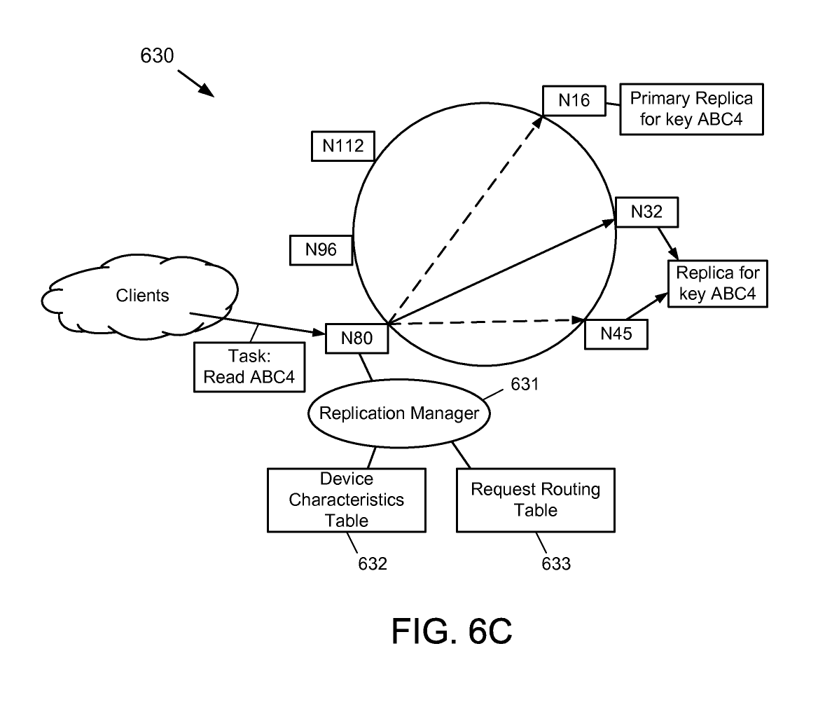

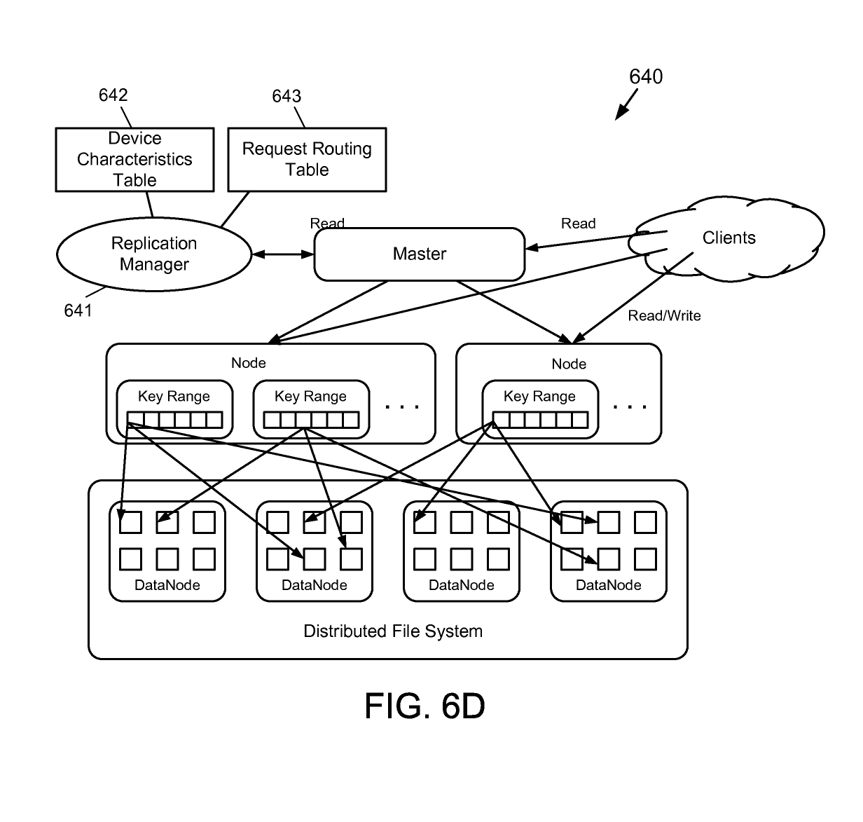

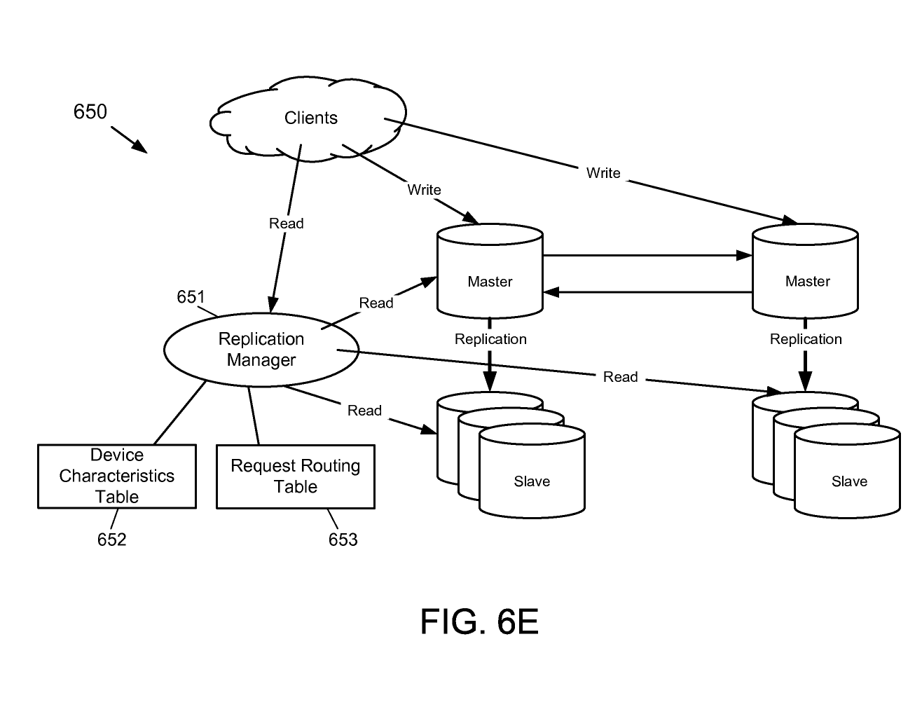

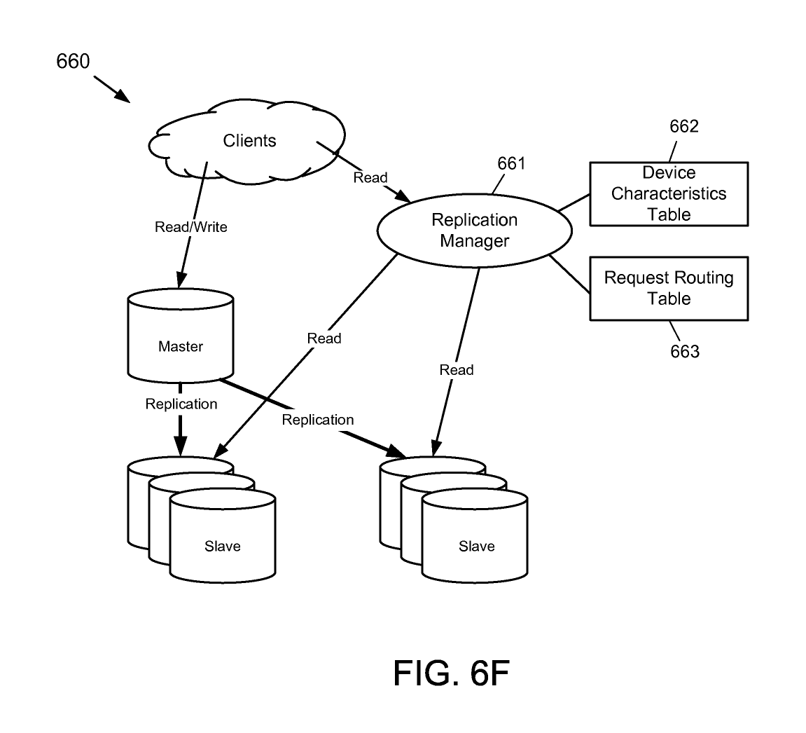

FIG. 6A depicts a configuration of a distributed storage system 610 that uses synchronous replication by partitioning data. For distributed storage system 610, the same partition data is updated synchronously in memory on different nodes. Typically in a distributed storage system that uses synchronous replication by partitioning data there is central metadata at the replication manager, and there are at least two replicas—a Master and Hot Standby. Additional replicas could be stored on different nodes that are not shown in FIG. 6A, as indicated by the ellipses. Any and/or all of the nodes could include persistent storage devices. Requests are received from clients located, for example, somewhere in “the Cloud.” Write requests are synchronously updated at both the Master and the Hot Standby. Read requests are routed to the Master, and the Hot Standby acts as the Master if master goes down. If no Hot Standby is available, the Master logs synchronously to the local disk to respond to a request. Examples of distributed storage systems using synchronous replication include Aerospike, VoltDB and eXtremeDB.

According to an exemplary embodiment, a replication manager 611 for a distributed storage system 610 that uses synchronous replication by partitioning data utilizes persistent storage device characteristics, as disclosed herein, to avoid routing a read request to a replica on a persistent storage device that may soon undergo a garbage collection operation. The replication manager 611 utilizes a device characteristics table 612, which contains information such as, but not limited to, a free block count and partition address information, and a request routing table 613, as described herein, and selects the replica at the top of the request routing table 613 that has the highest free block count among the replicas for that data partition. The replication manager 611 routes read requests received from clients as disclosed herein without interfering with a garbage collection operation on a persistent device.

FIG. 6B depicts a configuration of a distributed storage system 620 that uses synchronous pipelined replication in which data is written to selected replicas in a pipelined fashion. Distributed storage system 620 includes a replica-ordering policy that is only based on network topology. In the conventional configuration of a distributed storage system, the Master acts as the replication manager and, consequently, includes replication manager 621. Read requests are received by the Master from a Client at 1. The Master determines the correct data partition for a read request. The replication manager 621 determines the replicas associated with the data partition corresponding to the read request, and selects the replica at the top of the request routing table 623 that has the highest free block count among the replicas for that data partition. The replication manager 621 provides the exact replica location to the Master to directly route the read request to the replica location in a synchronous pipelined replication mechanism. The Master responds to the Client at 2 providing replication location information. At 3, the client pushes data to all replicas in a pipelined fashion based on the network topology to reduce bandwidth use. After all replicas acknowledge receiving data, at 4 the client sends a write request to the primary replica. At 5, the primary replica forwards the write request to all secondary replicas. Each secondary replica applies mutations in the same serial number order assigned by the primary replica. At 6, the secondary replicas reply to the primary replica indicating that the operation has completed. At 7, the primary replica sends an acknowledgement to the client. Examples of distributed storage systems using a synchronous pipelined replication include the Google File System (GFS) and the Hadoop Distributed File System (HDFS).

According to an exemplary embodiment, a replication manager 621 for a distributed storage system 620 that uses synchronous pipelined replication in which data is written to selected replicas in a pipelined fashion utilizes persistent storage device characteristics, as disclosed herein, to avoid routing a read request to a replica on a persistent storage device that may soon undergo a garbage collection operation. That is, the replication manager 621 utilizes a device characteristics table 622, which contains information such as, but not limited to, a free block count and partition address information, and a request routing table 623, as described herein. The replication manager 621 accordingly routes read requests received from clients as disclosed herein without interfering with a garbage collection operation on a persistent device.

FIG. 6C depicts a configuration of a distributed storage system 630 that uses asynchronous replication by consistent hashing in which a cluster of storage devices (nodes) acts as a peer-to-peer distributed storage system. One node, which is a coordinator, acts as replication manager 631. For this system configuration, a few coordinators can be configured per data center, or each machine can be configured to be a coordinator in a peer-to-peer distributed storage systems. For example, in FIG. 6C, distributed storage system 630 comprises a plurality of nodes N80, N96, N112, N16, N32 and N45 that are coupled together as a peer-to-peer distributed storage system. Node N80 acts as the coordinator. A client located somewhere in “the Cloud” sends a request that is received by node N80. As depicted in FIG. 6C, a read request key for ABC4 has been sent to node N80, which acts as the replication manager 631 and routes the read request to one of nodes N16, N32 or N45. In FIG. 6C, the solid arrow between nodes N80 and N32 depicts that the read request is, for this example, being routed to node N32. The dashed arrows between nodes N80 and N16 and nodes N80 and N45 depicts that the same data partition as requested is stored on nodes N16 and N80, and the read request could have been routed to either node N16 or node N45. Examples of distributed storage systems that use asynchronous consistent hashing based replication include Cassandra, CouchBase, Openstack Swift, Dynamo and Memcached.

According to an exemplary embodiment, a replication manager 631 for a distributed storage system 630 that uses asynchronous replication by consistent hashing in which a cluster of storage devices (nodes) acts as a peer-to-peer distributed storage system utilizes persistent storage device characteristics, as disclosed herein, to avoid routing a read request to a replica on a persistent storage device that may soon undergo a garbage collection operation. The replication manager 631 utilizes a device characteristics table 632, which contains information such as, but not limited to, a free block count and partition address information, and a request routing table 633 as described herein. The replication manager 631 routes read requests received from clients as disclosed herein without interfering with a garbage collection operation on a persistent device.

FIG. 6D depicts a configuration of a distributed storage system 640 that uses asynchronous replication by replicating the partitioned range of configurable size and in which a cluster in the distributed storage system has a master node. The master stores all the metadata information and interacts with a replication manager before forwarding clients to access the specific nodes in the distributed system. Typical distributed storage systems that use asynchronous replication by replicating the partitioned range of configurable size include, for example, Bigtable and Hbase.

According to an exemplary embodiment, a replication manager 641 for a distributed storage system 640 that uses asynchronous replication by replicating the partitioned range of configurable size in which a cluster in the distributed storage system has a master node utilizes persistent storage device characteristics, as disclosed herein, to avoid routing a read request to a replica on a persistent storage device that may soon undergo a garbage collection operation. The replication manager 641 utilizes a device characteristics table 642, which contains information such as, but is not limited to, a free block count and partition address information, and a request routing table 643 as described herein. In particular, the replication manager 641 selects the replica at the top of the Request Routing Table 643 that has the highest free block count among the replicas for that data partition. The replication manager 641 routes read requests received from clients as disclosed herein without interfering with a garbage collection operation on a persistent device.

FIG. 6E depicts a configuration of a distributed storage system 650 that uses synchronous/asynchronous multi-master or master-slave replication with manual data partitioning. Writes are always performed on the masters and the masters synchronize updates with each other. The replication manager plays an essential role in routing most of the read requests to slaves to relieve the load on the master in order to perform writes efficiently. Typical distributed storage systems that use synchronous/asynchronous multi-master or master-slave replication with manual data partitioning include, for example, most relational databases, MongoDB, and Redis.

According to an exemplary embodiment, a replication manager 651 for a distributed storage system 650 that uses synchronous/asynchronous multi-master or master-slave replication with manual data partitioning persistent storage device characteristics, as disclosed herein, to avoid routing a read request to a replica on a persistent storage device that may soon undergo a garbage collection operation. The replication manager 651 utilizes a device characteristics table 652, which contains information such as, but not limited to, a free block count and partition address information, and a request routing table 653, as described herein, and selects the replica at the top of the request routing table 653 that has the highest free block count among the replicas for that data partition. The replication manager 651 routes read requests received from clients as disclosed herein without interfering with a garbage collection operation on a persistent device.

FIG. 6F depicts a configuration of a distributed storage system 660 that uses a master-slave replication topography. In master-slave replication topography, similar to master-master topography, writes are always performed on the master. The replication manager plays an essential role in routing most of the read requests to slaves to relieve the load on the master to perform writes efficiently.

According to an exemplary embodiment, a replication manager 661 for a distributed storage system 660 that uses a master-slave replication environment utilizes persistent storage device characteristics, as disclosed herein, to avoid routing a read request to a replica on a persistent storage device that may soon undergo a garbage collection operation. The replication manager 661 utilizes a device characteristics table 662, which contains information such as, but not limited to, a free block count and partition address information, and a request routing table 663, as described herein, and the replication manager 661 selects the replica at the top of the request routing table 663 that has the highest free block count among the replicas for that data partition. The replication manager 661 routes read requests received from clients as disclosed herein without interfering with a garbage collection operation on a persistent device.

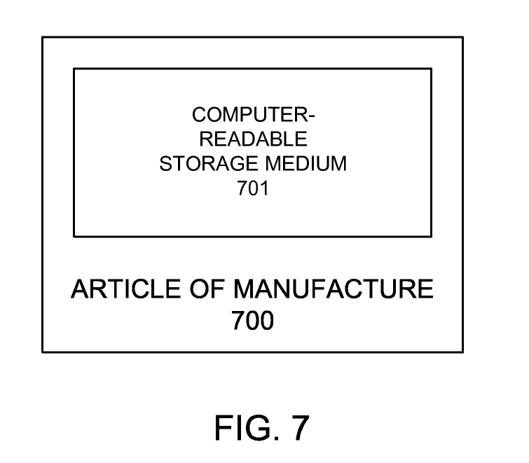

FIG. 7 depicts an exemplary embodiment of an article of manufacture 700 comprising a non-transitory computer-readable storage medium 701 having stored thereon computer-readable instructions that, when executed by a computer-type device, results in any of the various techniques and methods to improve read query performance in a distributed storage system by utilizing characteristics of persistent storage devices, such as free block count and device type characteristics, according to the subject matter disclosed herein. Exemplary computer-readable storage mediums that could be used for computer-readable storage medium 701 could be, but are not limited to, a semiconductor-based memory, an optically based memory, a magnetic-based memory, or a combination thereof.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the subject matter disclosed herein. Accordingly, all such modifications are intended to be included within the scope of the appended claims.

What is claimed is:

1. A method, comprising:
determining a free block count for each persistent storage device of a plurality of persistent storage devices in a distributed storage system, the plurality of persistent storage devices storing a plurality of replicas of data;
determining an ordering of the replicas of data stored on the plurality of persistent storage devices based on the determined free block count; and
load balancing read queries by routing a read query to a replica location based on the determined ordering of replicas.

2. The method according to claim 1, further comprising reordering a replica from the ordering of replicas if the replica is associated with a persistent storage device comprising a free block count that is less than or equal to a predetermined amount of free blocks.

3. The method according to claim 2, further comprising triggering a garbage collection operation for the persistent storage device.

4. The method according to claim 1, further comprising updating the ordering of replicas by:
determining an updated free block count for each persistent storage device of a plurality of persistent storage devices in the distributed storage system; and
determining an updated ordering of replicas stored on the plurality of persistent storage devices based on the determined updated free block count.

5. The method according to claim 4, further comprising:
determining a device type for each persistent storage device; and
determining the updated ordering of replicas stored on the plurality of persistent storage devices further based on the device type.

6. The method according to claim 1, wherein at least one persistent storage device comprises a solid-state drive (SSD) or a Non-Volatile Memory Express (NVMe) device.

7. The method according to claim 1, wherein the distributed storage system comprises a replication environment comprising a synchronous replication by partitioning data environment, a synchronous pipelined replication environment, an asynchronous replication by consistent hashing environment, an asynchronous range partitioned replication environment, a multi-Master replication environment, or a master-slave replication environment.

8. A replication manager for a storage system, comprising:
an input/output (I/O) interface to receive free block count information for each persistent storage device of a plurality of persistent storage devices in the storage system, one or more replicas of data stored in the storage system being stored on the plurality of persistent storage devices;
a device characteristics sorter to sort the received free block count information for each persistent storage device;
a routing table sorter to sort a routing table of the replicas of data stored on the plurality of persistent storage devices based on the free block count for each persistent storage device and to identify in the table replicas of data stored on persistent storage device having a free block count less than or equal to a predetermined amount of free blocks; and
a read-query load balancer to select a replica for a received read query by routing the received read query to a location of the selected replica based the table of the replicas of data stored on the plurality of persistent storage devices.

9. The replication manager according to claim 8, wherein the read-query load balancer selects a replica further based on an average latency of each of the plurality of persistent storage devices in the routing table that has not been identified to have a free block count less than or equal to the predetermined amount of free blocks.

10. The replication manager according to claim 8, wherein the replication manager is further to trigger a garbage collection operation for persistent storage device removed from the routing table.

11. The replication manager according to claim 8, wherein the I/O interface is to further receive updated free block count information for each persistent storage device of a plurality of persistent storage devices in the storage system;
wherein the device characteristics sorter is to further sort the updated received free block count information for each persistent storage device;
wherein the routing table sorter is to further update the routing table of the replicas of data stored on the plurality of persistent storage devices based on the updated free block count for each persistent storage device; and
wherein the read-query load balancer is to further select a replica for a received read query by routing the received read query to a location of the selected replica based the updated ordering of the replicas of data stored on the plurality of persistent storage devices.

12. The replication manager according to claim 8, wherein at least one persistent storage device comprises a Solid-State Drive (SSD) or a Non-Volatile Memory Express (NVMe) device.

13. The replication manager according to claim 8, wherein the storage system comprises a replication environment comprising a synchronous replication by partitioning data environment, a synchronous pipelined replication environment, an asynchronous replication by consistent hashing environment, an asynchronous range partitioned replication environment, a multi-Master replication environment, or a master-slave replication environment.

14. A non-transitory machine-readable medium comprising a plurality of instructions that in response to being executed on a computing device cause the computing device to prioritize access to replicas stored on a plurality of persistent storage devices in a distributed storage system by:
determining a free block count for each persistent storage device of a plurality of persistent storage devices in a distributed storage system, the plurality of persistent storage devices storing a plurality of replicas of data;
determining an ordering of the replicas of data stored on the plurality of persistent storage devices based on the determined free block count; and
load balancing read queries by routing a read query to a replica location based on the determined ordering of replicas.

15. The non-transitory machine-readable medium according to claim 14, further comprising reordering a replica from the ordering of replicas if the replica is associated with a persistent storage device comprising a free block count that is less than or equal to a predetermined amount of free blocks.

16. The non-transitory machine-readable medium according to claim 14, wherein load balancing read queries is further based on an average latency of each of the plurality of persistent storage devices.

17. The non-transitory machine-readable medium according to claim 14, further comprising instructions for triggering a garbage collection operation for the persistent storage device if the free block count associated with the persistent storage device is less than or equal to the predetermined amount of free blocks.

18. The non-transitory machine-readable medium according to claim 14, further comprising instructions for updating the ordering of replicas by:
determining an updated free block count for each persistent storage device of a plurality of persistent storage devices in the distributed storage system; and
determining an updated ordering of replicas stored on the plurality of persistent storage devices based on the determined updated free block count.

19. The non-transitory machine-readable medium according to claim 14, wherein at least one persistent storage device comprises a solid-state drive (SSD) or a Non-Volatile Memory Express (NVMe) device.

20. The non-transitory machine-readable medium according to claim 14, wherein the distributed storage system comprises a replication environment comprising a synchronous replication by partitioning data environment, a synchronous pipelined replication environment, an asynchronous replication by consistent hashing environment, an asynchronous range partitioned replication environment, a multi-Master replication environment, or a master-slave replication environment.
